(19) United States
(12) Patent Application Publication
(10) Pub. No.: US 2021/0361519 A1
(43) Pub. Date: Nov. 25, 2021

(54) Mounting Bracket for a Massage Gun

(71) Applicant: Doug Hagy, Los Angeles, CA (US)

(72) Inventor: Doug Hagy, Los Angeles, CA (US)

(21) Appl. No.: 17/303,163

(22) Filed: May 21, 2021

Related U.S. Application Data
(60) Provisional application No. 62/704,695, filed on May 22, 2020.

(51) Int. Cl. A61H 7/00

(52) U.S. Cl. CPC A61H 7/005; A61H 2201/0123; A61H 2201/0126

(57) ABSTRACT

A massage gun clamping device for a hand held device, that has a handheld device holding part having a flat surface that presses against an end of a wall, and first and second clamping parts that hold to sides of the wall. The clamping device holds a handheld massage gun in place so it can be pressed against body parts of a user. A foam pad is held between the flat surface and the end of the wall to prevent vibration of the massage gun causing excess noise or loosening of the clamp.

This application claims priority from provisional application No. 62/704,695, filed May 22, 2020, the entire contents of which are herewith incorporated by reference.

### BACKGROUND

Massage guns are very popular for to help with muscle soreness/pain and stiffness. The legs and arms of the body can be reached comfortably with a massage gun and therefore can be easily massaged with such a massage gun. However the neck and back muscles are not as easily reached. Users must contort themselves to reach those neck and back muscles.

### SUMMARY OF THE INVENTION

The inventor recognized a number of drawbacks with the current systems, which do not allow massage guns to easily reach to certain areas of a users' body.

The present application describes a mounting bracket having surfaces to hold a massage gun relative to a wall or other support. The mounting bracket is set in the right location, angle and position on the support to allow the massage gun to massage a specified location on the person's body.

According to an embodiment, a clamp is provided which connects to a wall or other support. The massage gun can be held in the clamp, on the wall. The massage gun is held by surfaces of the handle of the massage gun, and in a way that is facing an area on the person's body which is more difficult to reach with the users hand(s), such as the back.

An embodiment describes a massage gun holding clamp, that holds onto a specified wall portion.

An embodiment includes an elastomeric pad that is held between the massage gun holding clamp and the actual support, to prevent the support from vibrating as the massage gun is operated, and to prevent vibration in the wall, and to prevent the bracket from tilting forward.

### BRIEF DESCRIPTION OF THE DRAWINGS

In the Drawings:

FIG. 1 shows a drawing of the clamp, on a wall section, with the massage gun attached;

FIG. 2A illustrates a top view of the clamp, showing the different parts and certain axes in the structure;

FIG. 2B shows the inside surfaces of the clamp;

FIG. 3 shows the clamp attached to a wall from the first side with the massage gun attached;

FIG. 4 shows the action of inserting the massage gun into the clamp; and

FIG. 5 shows a user using the massage gun as held in the clamp on the wall, in order to reach an otherwise hard to reach location.

### DETAILED DESCRIPTION

The present application describes a clamp or holder to be used with a hand-held device that has a handle. In an embodiment, the hand held device is a massage gun and the clamp holds the massage gun on and relative to a support. The support is preferably a fixed support, such as a wall. In an embodiment, the wall to receive the holder is an end wall part with two opposite facing sides, such as a doorway.

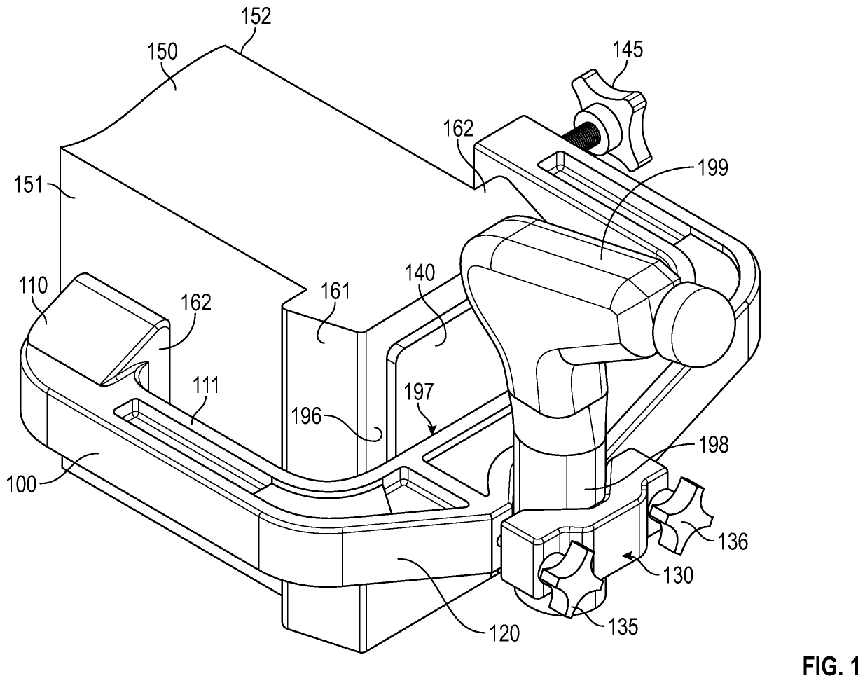

FIG. 1 shows the holder 100 being held against an end section 150 of a wall. The rear flat front surface 197 of the clamp, which is opposite to the front surface that holds the massage gun 199, is a flat surface that is pressed flat against the flat surface of the wall 196. As described further herein, an elastomeric sheet 140 is preferably located between the rear flat surface 197 and the wall surface 196.

The end section of the wall shown having a first wall side 151 and an oppositely facing second wall side 152 with the flat surface 196 of the wall extending between ends of the first wall side 151 and the second wall side 152. The holder clamp 100 includes a first clamping portion 110 which presses against the first side 151 of the wall. This first clamping portion 110 forms an indent at 162 so that the surface of the clamping portion 110 extends inwardly further than the inside surface 111 of the arm of the clamp. This allows the clamp to extend over, for example, a molding 162 of the wall if such is present.

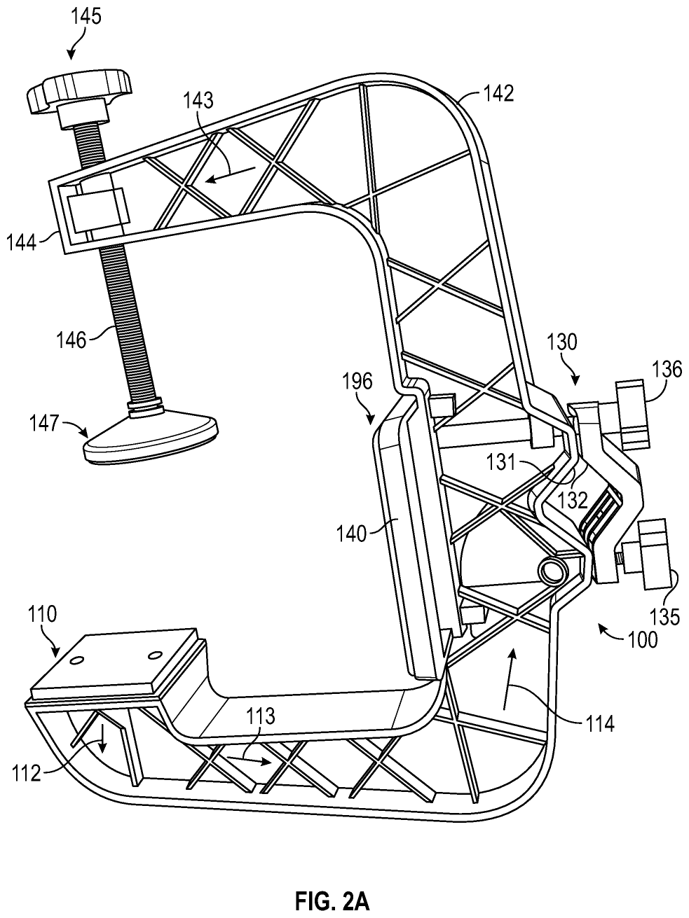

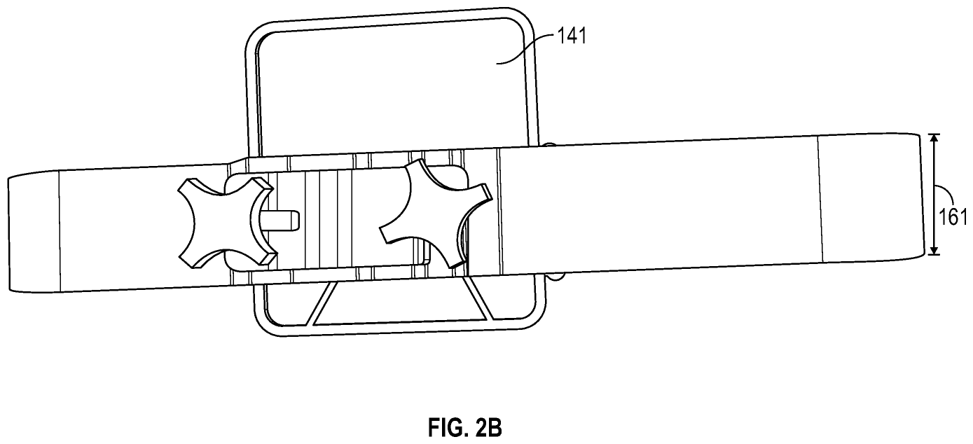

As shown in FIG. 2A, the clamp extends along an axis shown as 112 away from the wall and then along a perpendicular axis shown as 113 which is parallel to to the first side of the wall. The side portion of the clamp then curves or bends and extends along another axis 114 which is substantially parallel to the axis 112, but spaced there from. The area along the axis 114 forms the front portion 120 of the clamp. The rear portion 197 of that front portion 120 presses against the wall surface. The front portion 120 has a massage gun holding area shown generally as 130. This includes a first inner surface 131 for the backside of the massage gun handle and a front surface 132 for the front side of the massage gun handle.

The massage gun itself 199 is also shown in FIG. 1, which is held between the front and rear surfaces 131 and 132.

Closing screws 135, 136 can be tightened and loosened to adjust a distance between the front inner surface 132 and the rear inner surface 131. The screws 135, 136 can alternately be any other clamping option which can include other kinds of clamps such as hinges, or other latching mechanisms, and sizes and arrangements to adapt of other kinds and brands of massage guns.

Behind the rear surface 131, and between that rear surface 131 and the wall, is a foam pad 140 which is mounted on a foam pad holder 141 which is larger in width than the width 161 of the clamp device, see FIG. 2B. The foam pad is of a size to hold between the rear 196 of the front portion of the clamp 120 and the wall. Since the massage gun will create vibration, the foam pad 140 prevents this vibration from either harming the wall, or causing excess noise, or vibrating the clamp loose from its attached position on the wall. The foam pad holder 141 is shown as a square, but can be a rectangle or any shape.

The other side of the clamp, the right side in FIG. 1, extends to another curved portion at 142, curving to extend along another axis 143 which is parallel to the axis 113 but spaced therefrom. This extends to an end portion 144 where is located another clamping mechanism. The clamping mechanism has a screw knob 145 that adjusts the length of the screw clamp 146 which includes a movable end 147 that holds the clamp to the wall side.

This structure enables holding the movable clamp part 110 against one wall side; and tightening the movable clamp part 147 against the other wall side.

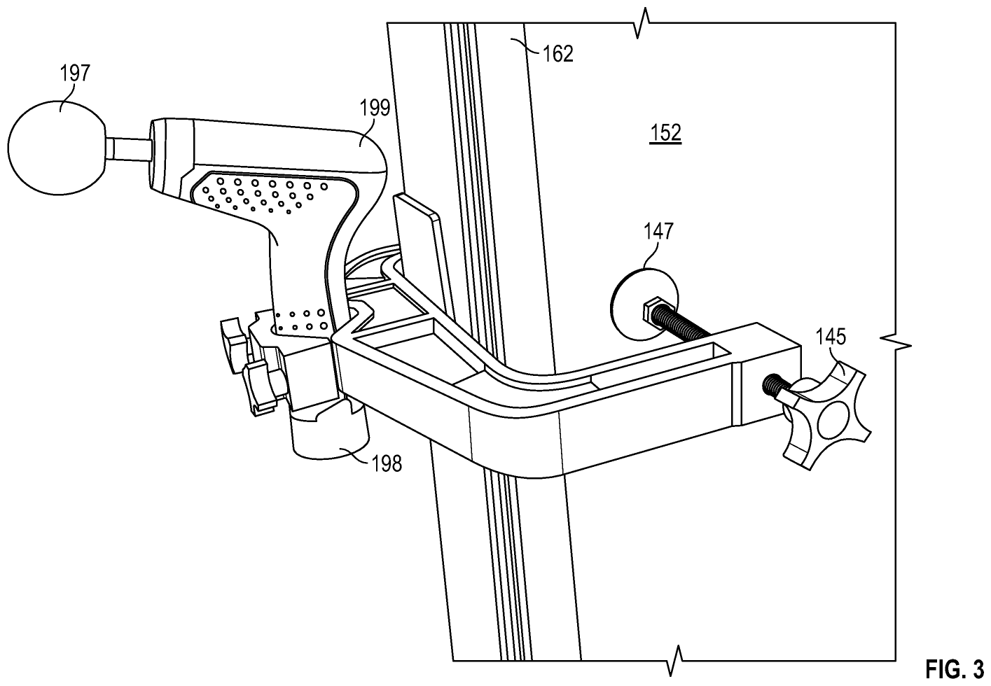

FIG. 3 illustrates the structure from the right side, showing the clamping screw 145 with the clamping surface 147 extending around the molding 162 and held to the wall 152. There is a first distance between the clamping surface, and an inside surface of the arm, and this first distance allows the arm to extend around a molding on the wall, shown generally as 162, The massage gun 199 is shown held in the clamp, with the handle 198 of the massage gun held between the front and rear surfaces 131, 132. This has the effect of locating the massaging part 197 of the massage gun 199 at a location where it can be used to massage the user's back or buttocks or other body part that would be difficult for the user to reach by themselves.

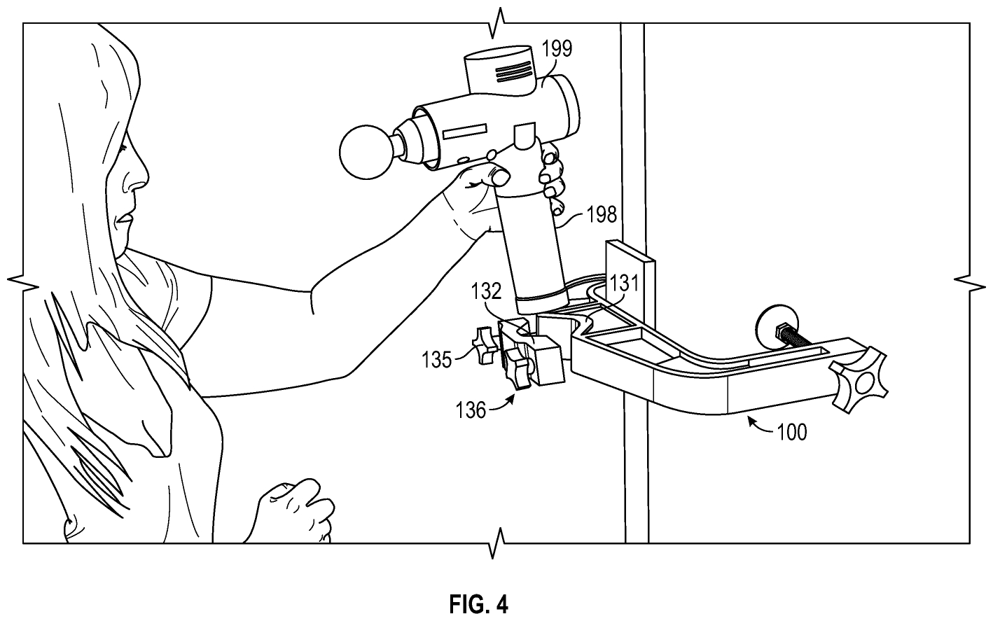

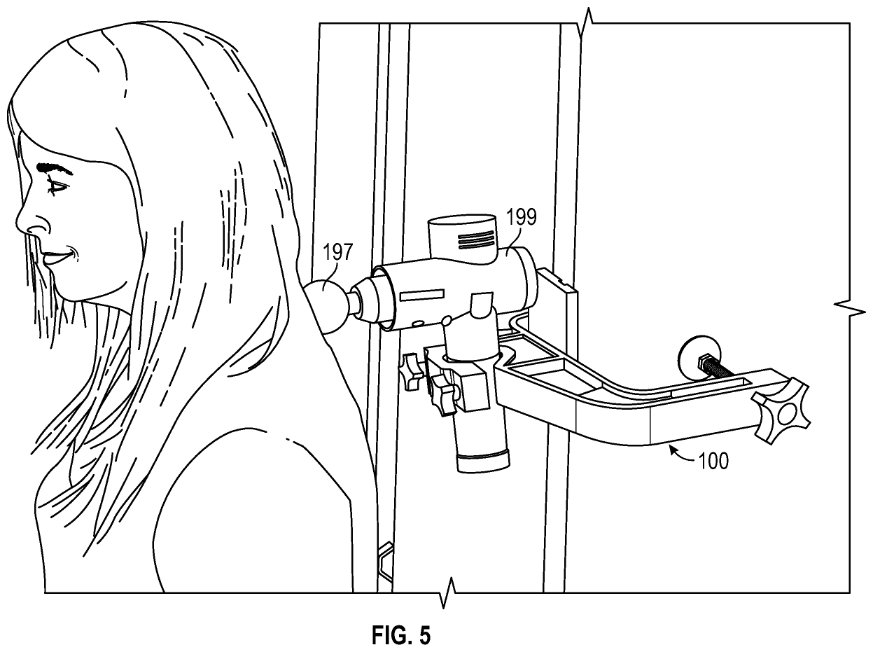

FIG. 4 illustrates the operation of putting the massage gun into the holder. The holder 100 is held to the wall as described herein. The massage gun holding surfaces 131 and 132 are opened using the screws 135 136. At this point, the handle 198 of the massage gun 199 is dropped into place between the surfaces 131, 132. The user positions the massage gun into position as desired, and then screws tight the surfaces 131 132 using the screws 135 136. At this point, the massage gun is held into place as shown in FIG. 5. The massaging end 197 of the massage gun in this embodiment is shown pressed against the users back in a location and at an angle where the user would not be themselves easily able to hold the massage gun. However the massage gun is held into place by the clamping action described herein.

The previous description of the disclosed exemplary embodiments is provided to enable any person skilled in the art to make or use the present invention. Various modifications to these exemplary embodiments will be readily apparent to those skilled in the art, and the generic principles defined herein may be applied to other embodiments without departing from the spirit or scope of the invention. For example, while the embodiments describe the clamp being used to hold the massage gun, it should be understood that any handheld device can be held by this clamp. Also, the embodiment shows the movable part of the clamp on the right side of the device, but of course the movable part can also and alternatively be placed on the left side. Movable clamping parts could also be placed on both sides, if desired Thus, the present invention is not intended to be limited to the embodiments shown herein but is to be accorded the widest scope consistent with the principles and novel features disclosed herein.

What is claimed is:

1. A clamping device for a hand held device, comprising:
a handheld device holding part having a first flat surface;
a first clamping part, having a first arm extending along a first axis, in a direction perpendicular to the first flat surface, and the first clamping part having a second surface facing in a first direction, the first surface facing in a direction perpendicular to the flat surface, and adapted to press against a first support, where there is a first distance between the second surface, and an inside surface of the first arm;
a second clamping part, having a second arm extending along an axis parallel to the first axis, the second clamping part having a third surface, facing in a second direction parallel and opposite to the first direction, adapted to press against a second support which is parallel to the first support but faces in an opposite direction to the first support;
the second flat surface being orthogonal to the first flat surface, and the third flat surface being orthogonal to the first flat surface and the third flat surface being parallel to the second flat surface; and
the handheld device holding part connected between the first and second arms and having surfaces which are sized and adapted to hold the handle of a handheld device, the surfaces being separable by loosening first and second connectors, and tightened by tightening the first and second connectors, and in the tightened position, adapted to hold the handle of the handheld device in place relative to the first and second and third flat surfaces.

2. The device as in claim 1, wherein the handheld device is a handheld massaging gun.

3. The device as in claim 2, wherein the support is an end of a wall with two parallel wall parts and a third facing wall part perpendicular to the two parallel wall parts, and where the first clamping part and the second clamping part press against the two parallel wall parts, and the flat surface presses against the third facing wall part.

4. The device as in claim 3, further comprising an elastomeric pad, located between the flat surface of the handheld device holding part and the third facing wall part.

5. The device as in claim 2, wherein the first clamping part is separated from the first arm by a first distance so that the first arm extends around a molding on the wall.

6. The device as in claim 5, wherein the first clamping part is stationary, and the second clamping part is movable.

7. The device as in claim 4, further comprising an elastomeric pad holder, holding the elastomeric pad, where the elastomeric pad holder has a thickness greater than a thickness of the clamping parts.
